(19) United States
(12) Patent Application Publication
(10) Pub. No.: US 2026/0341291 A1
(43) Pub. Date: Oct. 29, 2026

(54) SYSTEM AND METHOD FOR INJECTING VOICE ELEMENTS INTO AUDIO COMMUNICATION

(71) Applicant: Verizon Patent and Licensing Inc., Basking Ridge, NJ (US)

(72) Inventors: Peter Brockmann, Marlborough, MA (US); Jerry Gamble, JR., Grapevine, TX (US)

(21) Appl. No.: 19/193,200

(22) Filed: Apr. 29, 2025

(51) Int. Cl. G10L 21/02; H04B 17/318

(52) U.S. Cl. CPC G10L 21/02; H04B 17/318

(57) ABSTRACT

A system may include a processor. The processor may be configured to receive voice data; modify the received voice data in accordance with one or more hearing pathologies; and perform an intelligibility test on the received voice data and the modified voice data to obtain an intelligibility score. The processor may be further configured to boost energy of the received voice data to generate compensated voice data based on the intelligibility score; and provide the compensated voice data to another device or a component.

### BACKGROUND INFORMATION

Hearing aid devices can be realized in many ways. For example, in one implementation, hearing aid devices include small electronic devices designed to amplify sound for individuals with hearing loss, typically consisting of a microphone to capture sound, an amplifier to increase its strength, a speaker to deliver it into the ear, and a battery for power. Hearing aid devices come in various styles, including Behind-the-Ear (BTE), In-the-Ear (ITE), Receiver-in-Canal (RIC), and Completely-in-Canal (CIC), with modern models featuring Bluetooth connectivity, artificial intelligence (AI)-powered sound processing, noise reduction, and rechargeable batteries. Other implementations include smartphone integration, remote adjustments via tele-audiology, and highly customized solutions.

### BRIEF DESCRIPTION OF THE DRAWINGS

FIG. 1 illustrates concepts described herein.

FIG. 2 illustrates an exemplary network environment in which systems and methods described herein may be implemented.

FIG. 3A depicts example components of a voice injector according to an implementation.

FIG. 3B shows example components of a voice injector system, according to an implementation.

FIG. 4 depicts example components of a portion of a voice injector according to an implementation.

FIG. 5 is a flow diagram of an example process that is associated with injecting voice elements, according to an implementation.

FIG. 6 depicts exemplary functional components of a network device according to an implementation.

### DETAILED DESCRIPTION

The following detailed description refers to the accompanying drawings. The same reference numbers in different drawings may identify the same or similar elements. As used herein, the terms “service provider” and “provider network” may refer to, respectively, a provider of communication services and a network operated by the service provider. The network may include a cellular network. A cellular network may be uniquely identified by a Public Land Mobile Network (PLMN) Identifier (ID).

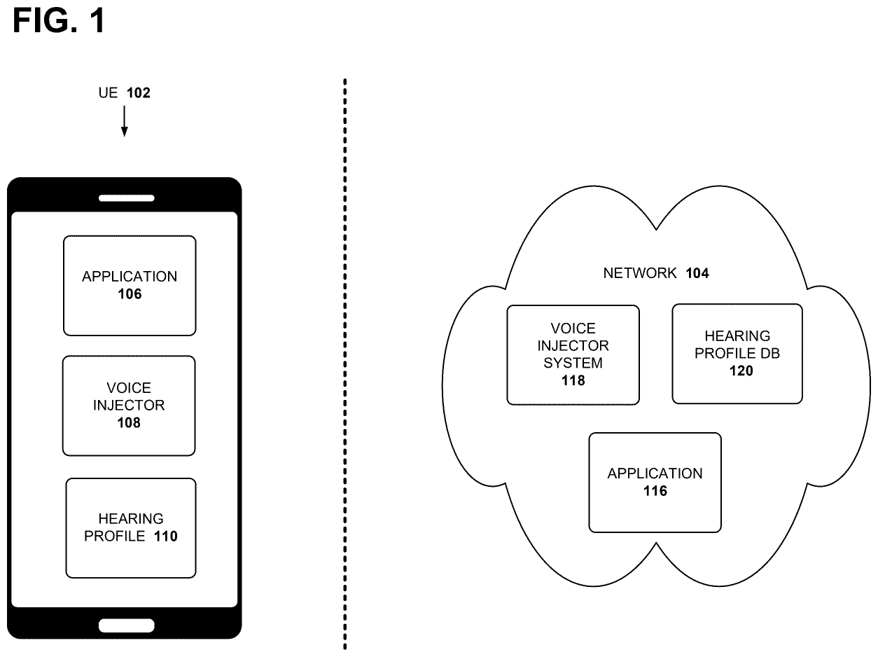

The systems and methods described herein relate to injection of voice elements into audio communications. Implementation may occur on a device receiving the audio communication or within a network, such as a cellular network. FIG. 1 illustrates these concepts. As shown, in one implementation, a User Equipment device (UE) 102 may include an application 106, a voice injector 108, and a hearing profile 110. Application 106 may process audio sound from the user by converting sound into audio signals, processing those signals, and transmitting the processed audio signals to another device. For example, application 106 may establish a session with an Internet Protocol (IP) Multimedia Subsystem (IMS) and transmit the audio signal over the established session.

Additionally, application 106 may receive an audio signal from another device, process the received signal, and generate sound corresponding to the audio signal for the user of UE 102. To facilitate this process, application 106 may utilize voice injector 108. Upon processing the signal, voice injector 108 may provide the modified signal to application 106, which then generates the corresponding sound, such as through UE 102 speakers.

In a different implementation, processing may occur within a network 104, such as a provider network. As illustrated, network 104 may include an application 116, a voice injector system 118, and a hearing profile database (DB) 120. Application 116 may function as an application server or a network function responsible for handling audio communication between UE 102 and another device, such as another UE 102. Examples of application 116 include digital phone applications, audio conference applications, and audio/video conference applications.

When managing audio communication from a specific UE 102, application 116 may utilize voice injector system 118, which may include voice injector 108 (like the one included in UE 102). To support this process, application 116 may access a hearing profile database 120 and provide data to voice injector system 118. Upon retrieval of a hearing profile 110 associated with the receiving UE 102, voice injector system 118 may supply the profile to voice injector 108 within system 118, for signal processing. Once the processed signal is obtained, application 116 may forward the modified signal to the receiving UE 102, over the communication session.

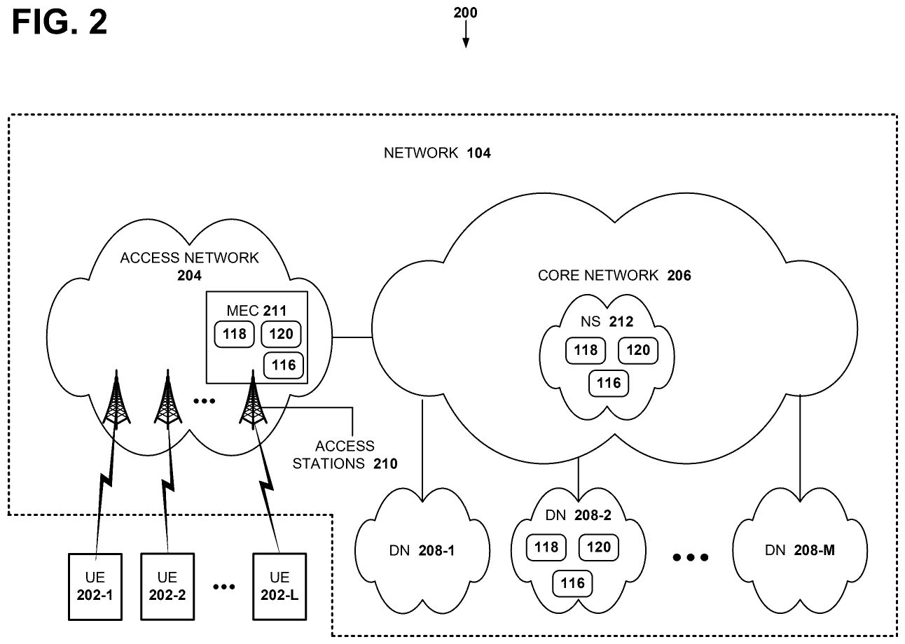

FIG. 2 illustrates an exemplary network environment 200 in which the systems and methods described herein may be implemented. As shown, network environment 200 may include User Equipment devices (UEs) 102-1 through 102-L (collectively referred to as UEs 102 and generically referred to as UE 102), access network 204, core network 206, and data networks (DNs) 208-1 through 208-M (collectively referred to as data networks (DNs) 208 and generically as data network (DN) 208). Access network 204, core network 206, and data networks 208 may be part of a provider network 104.

UEs 102 may include devices capable of Fourth Generation (4G) (e.g., Long-Term Evolution (LTE)) communication, 5G New Radio (NR) communication, and/or other wireless communication. Examples of UE 102 include: a smart phone; a tablet device; a smart watch; a global positioning system (GPS) device; a laptop computer; a media playing device; a portable gaming system; a desktop computer; Internet-of-Things (IoT) devices, such as sensors (e.g., temperature, humidity, water levels, chemical compounds, etc.); smart meters (e.g., water, gas, electricity, etc.); wearables (e.g., fitness trackers); asset trackers (e.g., vehicles, goods, etc.); Narrow Band (NB)-IoT devices; Long-Term Evolution (LTE) Cat-M1 devices; smart home devices (e.g., security cameras); industrial IoT devices (e.g., monitoring devices); medical devices (e.g., patient monitoring devices); agricultural devices (e.g., livestock trackers); and fleet management devices (e.g., vehicle telematics). Additional examples of UEs 102 include: a Fixed Wireless Access (FWA) device; a Customer Premises Equipment (CPE) device with 4G and 5G capabilities. In some implementations, UE 102 may include a wireless Machine-Type-Communication (MTC) device that communicates with other devices over a machine-to-machine (M2M) interface, such as LTE-M or CAT-M1 devices and NB-IoT devices.

In some implementations, UE 102 may include devices that may or may not be in communication with another device but nonetheless include voice application 106, voice injector 108, and/or hearing profile 110 (not shown in FIG. 2). For example, UE 102 may include a media player and application 106 may include an application capable of playing audio books. Voice injector 108 may operate in the manner described above to improve the intelligibility of the vocalized words for the user of UE 102 (a listener of the audio books).

Access network 204 may facilitate UE 102′s connection to core network 206 by establishing and managing over-the-air channels with UE 102 and backhaul channels with core network 206. These channels enable the relay of information between UE 102 and core network 206. Access network 204 comprises LTE, 5G NR, or other advanced radio access networks, featuring components such as central units (CUs), distributed units (DUs), radio units (RUs), and/or base stations. These network components are illustrated in FIG. 2 as access stations 210 (herein generically referred to as access station 210) for establishing and maintaining over-the-air channel with UEs 102. In some implementations, access station 210 may include a 4G, 5G, or another type of base station (e.g., evolved Node B (eNB), next generation Node B (gNB), etc.) that comprises one or more radio frequency (RF) transceivers. In some implementations, access station 210 may be part of an evolved Universal Mobile Telecommunications Service (UMTS) Terrestrial Radio Access Network (eUTRAN).

As further shown, access network 204 may include one or more Multi-access Edge computing Clusters (MECs) 211. MEC 211 may include a distributed group of edge servers located near the end users—typically at or near access stations—that provide low-latency, high-bandwidth computing resources. By processing data closer to the source, MEC clusters 211 reduce the need to send information to centralized cloud servers, enabling faster response times for applications such as augmented reality, autonomous vehicles, and real-time analytics. Within a 5G infrastructure, MEC clusters 211 are tightly integrated with the network's control and user planes, allowing dynamic resource allocation, localized data handling, and seamless support for ultra-reliable, low-latency communication (URLLC) and massive IoT deployments.

In some implementations, MEC clusters 211 may include (or may host) an environment (e.g., IMS) for hosting application 116, voice injector system 118, and/or hearing profile database 120.

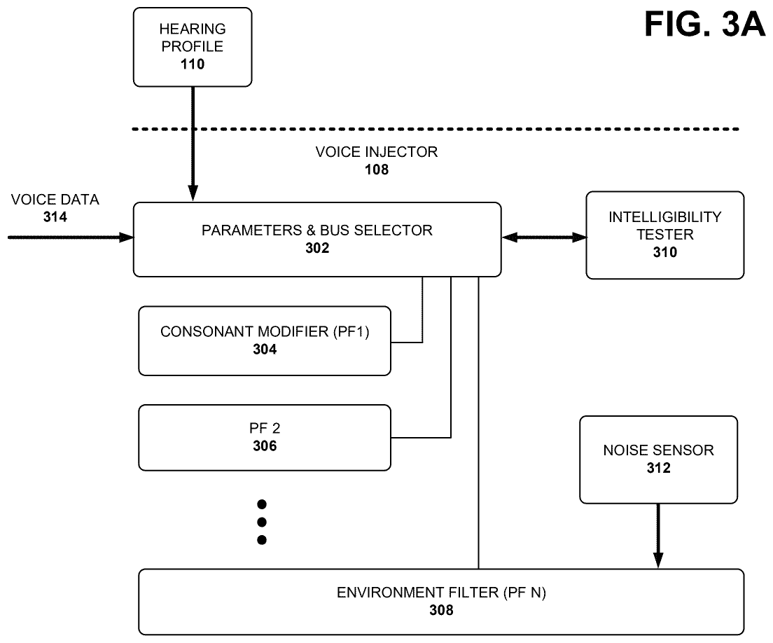

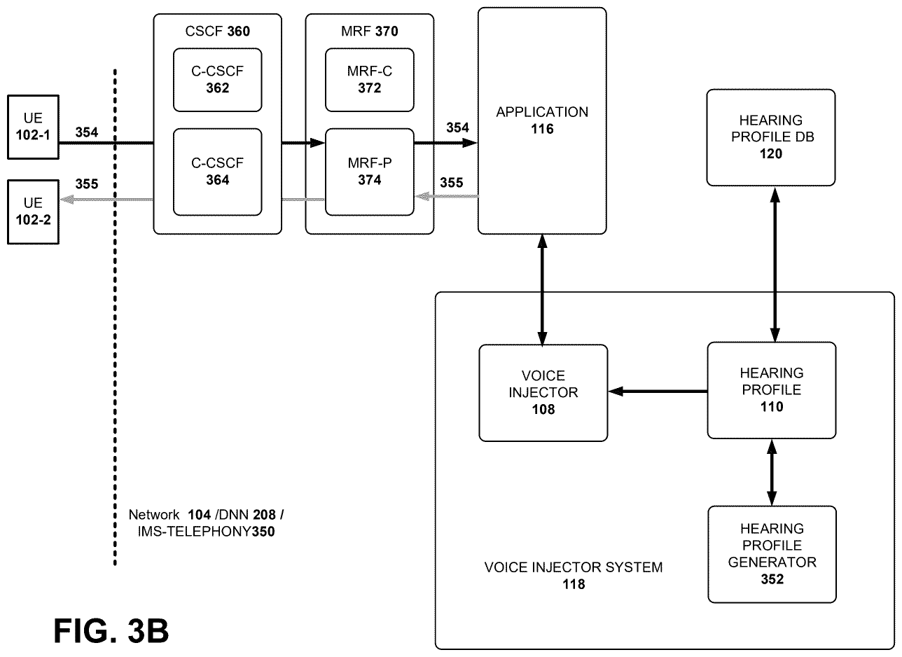

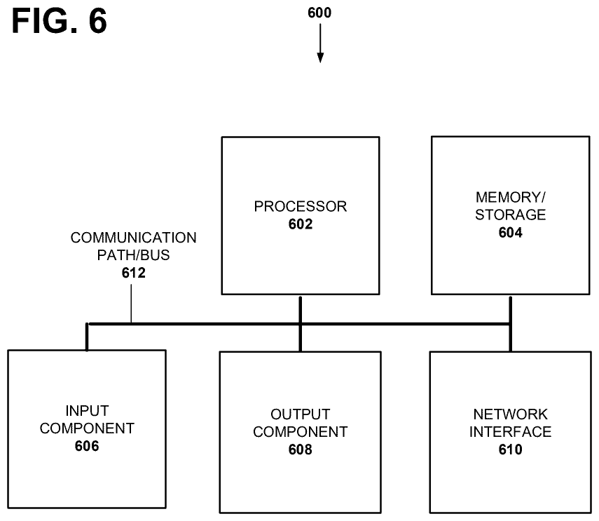

Core network 206 may oversee communication sessions for subscribers connecting via access network 204. For instance, core network 206 may facilitate the establishment of Internet Protocol (IP) connections between UEs 102 and data networks 208. The components within core network 206 can be either dedicated hardware elements or virtualized functions operating atop a shared physical infrastructure using Software Defined Networking (SDN). An SDN controller, for example, may leverage an adapter to implement one or more core network components through virtualized entities like virtual network functions (VNF) virtual machines, Cloud Native Function (CNF) containers, event-driven serverless architecture interfaces, or other SDN components. This shared physical infrastructure may include devices 600, as described below with reference to FIG. 6, within a cloud computing center associated with core network 206. Moreover, core network 206 may encompass 5G core network components, 4G core network components, or other types of core components. Further elaboration on some of these components is provided below with reference to FIG. 3.

As further shown, core network 206 may include one or more network slices (NS) 212. Depending on the embodiment, network slices 212 may be implemented within other networks, such as access network 204 and/or data network 208. Access network 204, core network 206, and data networks 208 may include multiple instances of network slices 212 (generically or individually referred to as network slice 212). Each network slice 212 may be instantiated as a result of “network slicing,” which involves a form of virtual network architecture that enables multiple logical networks to be implemented on top of a shared physical network infrastructure using SDN and/or network function virtualization (NFV). Each logical network, referred to as a “network slice,” may encompass an end-to-end virtual network with dedicated storage and/or computational resources that include access network components, clouds, transport network components, Central Processing Unit (CPU) cycles, memory, etc. Furthermore, each network slice 212 may be configured to meet a different set of requirements and may be associated with a particular Quality of Service (QoS) Class Identifier (QCI), a type of service, a 5G QoS Identifier (5QI), and/or a particular group of enterprise customers associated with communication devices. Network slices 212 may be capable of supporting enhanced Mobile Broadband (eMBB) traffic, Ultra Reliable Low Latency Communication (URLLC) traffic, Time Sensitive Network (TSN) traffic, Massive IoT (MIoT) traffic, Vehicle-to-Everything (V2X) traffic, High performance Machine Type Communication (HMTC) traffic, and other customized traffic, for example. As shown, a network slice 212 may include a system, such as an IMS, that includes application 116, voice injector system 118, and hearing profile database 120.

Each network slice 212 may be associated with an identifier, herein referred to as a Single Network Slice Selection Assistance Information (S-NSSAI) and/or a network slice instance ID. Each UE 102 that is configured to access a particular network slice 212 may be associated with corresponding data, stored in core network 206 for example, which includes the S-NSSAI that identifies the network slice 212. As shown, a network slice 212 may include a system, such as an IMS, that includes application 116, voice injector system 118, and hearing profile database 120.

Data networks 208 may include one or more networks connected to core network 206. In some implementations, a particular data network 208 may be associated with a data network name (DNN) in 5G and/or an Access Point Name (APN) in 4G. UE 102 may request a connection to data network 208 using a DNN or APN. In a 5G network, data network 208 that is implemented on network slice 212 may nonetheless be associated with a DNN. Each data network 208 may include, and/or be connected to and enable communications with, a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, and/or an LTE network), an ad hoc network, a telephone network (e.g., the Public Switched Telephone Network (PSTN) or a cellular network), an intranet, or a combination of networks. Data network 208 may include an AS (also referred to as application). An application may render services to other applications running on UEs 102 and may establish communication sessions with UEs 102 via core network 206. As shown, a data network 208 may include a system, such as an IMS, that in turn includes application 116, voice injector system 118, and hearing profile database 120.

For clarity, FIG. 2 does not show all components that may be included in network environment 200 (e.g., routers, bridges, wireless access points, additional networks, additional access stations 210, data centers, portals, etc.). Depending on the implementation, network environment 200 may include additional, fewer, different, or a different arrangement of components than those illustrated in FIG. 2.

FIG. 3A depicts example components of voice injector 108 according to an implementation. As shown, voice injector 108—which may be hosted on UE 102 or included in voice injector system 118—may include a parameters and bus selector 302, a consonant modifier (pathology filter (PF) 1) 304, a pathology filter 306 (PF 2), an environment filter 308 (PF N), an intelligibility tester 310, and a noise sensor 312. Depending on the implementation, voice injector 108 may include additional, fewer, or different components than those illustrated in FIG. 3A, or these components may be arranged differently. For example, in some implementations, voice injector 108 may not include pathology filters 2 through N.

Parameters and bus selector 302 may include logic for using Short-Term Intelligibility tests to inject voice elements into voice data. The injected voice elements may boost (or pre-distort) the signal in a particular manner, such that after the boosted signal is degraded by pathology filters PF 1, PF 2 . . . PF N, intelligibility tester 310 obtains the optimal match between voice data 314 and the degraded signal.

For example, parameters and bus selector 302 may receive input voice data 314, boost input voice data 314 by applying voice injection parameters obtained from intelligibility tester 310, apply hearing pathology data from hearing profile 110 to degrade the boosted voice data 314, and use intelligibility tester 310 to evaluate both input voice data 314 and the degraded voice data (e.g., by comparing them) to determine voice injection parameter values (e.g., intelligibility scores). The goal is to obtain voice injection parameters, which when applied, yields boosted signal, that when degraded by pathology filters, yields the best intelligibility. Parameters and bus selector 302 may then use the voice injector parameters to inject voice elements into the voice data and provide the boosted voice data.

Pathology filters (e.g., PF 1 304, PF 2 306, . . . PF N 308) may include parameters associated with the degradation of input voice data 314 in accordance with specific hearing pathologies. To degrade the input voice data 314, parameters and bus selector 302 may select one or more pathology filters (e.g., PF 1, PF 2, . . . PF N) and provide corresponding input parameter values to the selected filters, based on the data from hearing profile 110. The degradation may be applied to the signal that has been boosted in accordance with the voice injector parameter values.

For example, consonant modifier 304 (PF 1) may include data representing the degradation of consonant sounds, which are one of the two primary components of speech sounds (vowels and consonants). As used herein, the term “vowels” refers to voiced sounds resulting from air from the lungs being modulated by the vocal cords. These sounds are typically characterized by quasi-periodic excitations dominated by relatively low-frequency oscillation pitches. As used herein, the term “consonants” refers to the set of plosives and fricatives. Plosives include sounds made by completely stopping and then releasing airflow, such as/p/ (as in pat), /b/ (as in bat), /t/ (as in top), /d/ (as in dog), /k/ (as in cat), and /g/ (as in go). Fricatives are produced by forcing air through a narrow constriction, creating friction. Fricatives include /f/ (as in fan), /v/ (as in van), /s/ (as in sun), /z/ (as in zoo), /∫/ (as in shoe), /3/ (as in measure), /θ/ (as in thing), and /ð/ (as in this).

Consonant modifier 304 may detect particular consonants and the degradation of those consonants as perceived by a listener. In one implementation, consonant detection may be performed by first converting incoming audio signals into spectrograms (e.g., a time-frequency representation) or Mel-spectrograms, and then applying a deep neural network, specifically a convolutional neural network, which has been trained to recognize spectrogram patterns corresponding to consonants and/or the parts of the signal correcting to the filtered hearing pathologies. In a different implementation, a sequence model (e.g., a Hidden Markov Model (HMM)) may be used in place of convolutional neural networks and/or deep neural networks. Once the consonant or problem speech component is detected, the corresponding portion of the audio signal may be degraded (reshaped) in accordance with the data stored in hearing profile 110. Parameters and bus selector 302 may provide pre-distorted or boosted voice data 314 to consonant modifier 304.

Environment filter 308 may degrade voice data based on ambient noise (or other environmental noise) detected via noise sensor 312. Noise sensor 312 may detect noise present in the environment where the sound is produced. In some implementations, voice injector 108 may not include environment filter 308 and/or noise sensor 312, particularly if noise reduction functionality is handled at or near the source of the voice data. In other implementations, external devices coupled to UE 102 (e.g., earphones or earbuds) may provide the noise cancellation or elimination functionality.

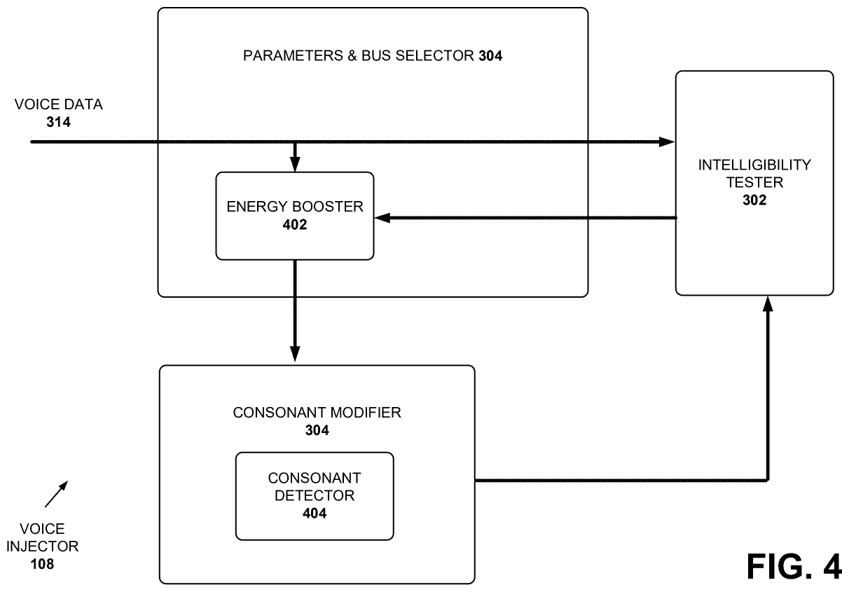

Intelligibility tester 310 may provide the result of applying Short-Term Objective Intelligibility (STOI) tests or enhanced STOI tests to parameters and bus selector 302. Intelligibility tester 310 is described below in greater detail with reference to FIG. 4. Parameters and bus selector 302 may use the output of intelligibility tester 310 to generate modified voice data or signals.

FIG. 3B shows example components of voice injector system 118 in network 104, according to an implementation. As shown, network 104 (e.g., DNN 208/IMS-telephony network 350) may include a Call Session Control Function (CSCF) 360, a Media Resource Function (MRF) 370, application 116, hearing profile database 120, and a voice injector system 118. Depending on the implementation, network 104 may include additional, fewer, or different components than those illustrated in FIG. 3B. Furthermore, these components may additional, fewer, different, or a different arrangement of subcomponents than those illustrated in FIG. 3B.

CSCF 360 may include Proxy CSCF (P-CSCF) 362 and Serving CSCF (S-CSCF) 364. C-CSCF 362 and S-CSCF 364 may perform operations on downstream flows or bearers 354 and 355 from UE 102-1 toward UE 102-2. Flows and/or bearers 354 and 355 may include, for example, media data (e.g., voice data) and its control signals (e.g., Session Initiation Protocol (SIP) signals). Flows 354 and 355 may be part of a single PDU session. C-CSCF 362 and S-CSCF 364 may also perform similar operations on upstream flows and bearers (which may be included in the same PDU session0, although not illustrated in FIG. 3B.

P-CSCF 362 may include a first contact point for endpoint UEs 102-1 and 102-2 within IMS-telephony network 350, act as a SIP proxy between UEs 102-1 and 102-2 and IMS-telephony network 350. P-CSCF 362 may perform SIP signaling compression and security management (e.g., IPSec with UEs 102-1 and 102-2), forward SIP messages to the appropriate Serving CSCF 364, control policy via interaction with policy-responsible functions in core network 206 (e.g., a Policy Control Function (PCF) in a 5G core or Policy and Charging Rules Function (PCRF) in a 4G core), and/or Network Address Translation (NAT) traversal, if necessary.

S-CSCF 364 may control sessions and routing in IMS-telephony network 350. S-CSCF 364 may perform functions such as SIP registration and routing, authentication using core network components (e.g., Home Subscriber Server (HSS) in a 4G core or Unified Data Management (UDM) in a 5G core); authentication via HSS/UDM; application of filter criteria to route requests to application server; and maintenance of call state and user session data.

MRF 370 may handle media resources. As further shown, MRF 370 may include MRF-Controller (MRF-C) 372 and MRF-Processor (MRF-P) 374. MRF-C 372 may control media processing (e.g., voice data in flow 356) for conferencing, tone generation, transcoding, etc. MRF-C 372 may receive instructions from the S-CSCF 362 or application 116 to set up media streams in flows 356 and/or 357.

MRF-P 374 may handle media stream processing of flows 354 and 355. The processing may include, for example, mixing audio for conferencing calls, playing announcements (e.g., “Your call cannot be completed . . . ”), transcoding between different codecs if needed, etc.

Application 116 and hearing profile database 120 have been described above. Voice injector system 118 may include voice injector 108, hearing profile 110, and hearing profile generator 352.

Voice injector 108 and hearing profile 110 have been described above with reference to FIG. 3A. Hearing profile generator 352 may obtain hearing profile data and provide the data to hearing profile 110 and/or hearing profile database 120. For example, hearing profile generator 352 may receive hearing-related data from an operator or from a user. In another example, hearing profile generator 352 may generate results from conducting a hearing test with the user of UE 102 (i.e., the device receiving the voice data output from voice injector system 118). Hearing profile data may indicate the degree of degradation associated with signals perceived as sound.

In FIG. 3B, when application 116 receives voice data 354 from UE 102 over a network connection (e.g., a data path such as a wireless link, wired link, or optical link), application 116 may identify the user of UE 102 and enable the transfer of hearing profile data from hearing profile database 120 to hearing profile 110, based on an identifier associated with UE 102 or the user (e.g., an International Mobile Subscriber Identity (IMSI), a Mobile Directory Number (MDN), a Mobile Station International Subscriber Directory Number (MSISDN), an International Mobile Equipment Identity (IMEI), or another type of UE device ID). In some embodiments, hearing profile database 120 or hearing profile 110 may be stored or accessed via a core network function, such as a Unified Data Management (UDM) or a Unified Data Repository (UDR) in core network 204.

Application 116 may process the voice data (e.g., perform network decompression) and provide the voice data to voice injector system 118 for modification. After voice injector system 118 modifies voice data 354, application 116 may forward the modified voice data to another network component or to UE 102.

FIG. 4 depicts example components of voice injector 108 in greater detail, according to an implementation. For clarity, FIG. 4 does not show all components of voice injector 108, although voice injector 108 may include additional functional components. In the context of FIG. 4, assume that hearing profile 110 includes voice injector parameters for consonant modification and that, based on hearing profile 110, parameter and bus selector 302 has selected consonant modifier 304 as its only pathology filter. As shown, parameter and bus selector 302 may include an energy booster 402, and consonant modifier 304 may include a consonant detector model (or simply consonant detector) 404.

In FIG. 4, when parameter and bus selector 302 receives voice data 314 (or voice data 354) from application 106, parameter and bus selector 302 may examine the output (i.e., voice injector parameters) from intelligibility tester 310 to determine whether the voice data 314 requires further processing. Assuming that the voice injector parameters indicate that additional processing is needed, parameter and bus selector 302 may send voice data 314 to intelligibility tester 310, process the voice data through energy booster 402—which boosts the energy of the signal in accordance with the output from intelligibility tester 310 (e.g., specifying which time-domain and spectral portions to boost and by how much, such as by 2%)—and forward the output of energy booster 402 to consonant modifier 304.

When consonant modifier 304 receives the energy-boosted signal from parameter and bus selector 302, consonant modifier 304 may detect consonants via consonant detector 404. As already described above, depending on the implementation, consonant detector 404 may include a deep neural network model, a convolutional neural network, a sequence model (e.g., Hidden Markov Model), and/or a combination of such models. In some implementations, these models may have been initially trained using Mel-Frequency Cepstrum Coefficients (MFCCs).

After detecting consonants, consonant modifier 304 may then modify the voice data or signal (e.g., by amplifying or degrading it) according to its configuration and forward the output to intelligibility tester 310. The specific consonants detected and modified by consonant modifier 304 may depend on its configuration, which is set by parameter and bus selector 302 based on data from hearing profile 110.

Intelligibility tester 310 may apply STOI or extended STOI to two signals: voice data 314 from parameter and bus selector 302 and the modified voice data from consonant modifier 304. A STOI test may include time-frequency decomposition, where a short-time Fourier transform (STFT) is applied to both the original and modified voice data to obtain time-frequency representations. The STOI test may then extract temporal envelopes from these representations, normalize and clip the envelopes to account for perceptual characteristics, and correlate the normalized and clipped envelopes across frequency bands and time frames. Intelligibility tester 108 may then average the correlations to produce a final STOI score.

Based on the score (e.g., a number ranging from 0 to 1), parameter and bus selector 302 may determine the appropriate amount of energy to boost in voice data 314 and perform the boost accordingly. Parameter and bus selector 302 may then output the final voice signal, either to application 106 or to another network component.

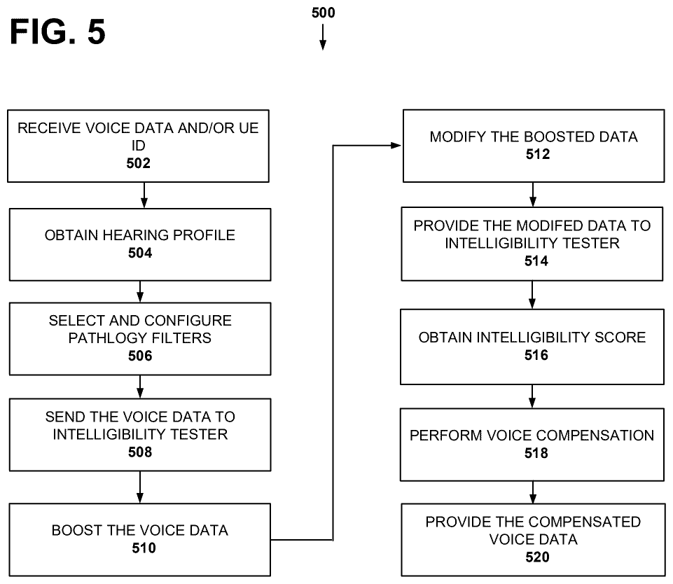

FIG. 5 is a flow diagram of an example process 500 associated with injecting voice elements, according to an implementation. In one embodiment, process 500 may be performed by application 106, voice injector 108, and/or hearing profile 110. In another embodiment, process 500 may be performed by application 116, voice injector system 118, and/or hearing profile database 120. In yet other implementations, process 500 may be performed not only by application 106, voice injector 108, hearing profile 110, application 116, voice injector system 118, and hearing profile database 120, but also by additional UE 102 components and/or network components.

As shown, process 500 may include receiving voice data and/or a UE ID (block 502). For example, UE 102 may receive voice data from network 104 over a wireless connection. In another example, application 106 on UE 102 may receive voice data through its network interface. In yet another example, application 116 may receive voice data from UE 102 over a network connection. In some embodiments, when application 116 receives the voice data, application 116 may also receive a UE ID, such as an MSISDN, an IMSI, an IMEI, or other identifier.

Process 500 may further include obtaining a hearing profile (block 504). For example, when application 116 receives the voice data and a UE ID, application 116 may use the UE ID as a key to retrieve the corresponding hearing profile 110 from hearing profile database 120. In another example, application 106 may access a local hearing profile 110 (e.g., one stored on UE 102).

Process 500 may further include selecting and configuring pathology filters (block 506). For example, when parameter and bus selector 302 in voice injector 108 obtains data from hearing profile 110, parameter and bus selector 302 may select one or more pathology filters (e.g., PF 1, PF 2 . . . PF N) and configure the selected filters. For instance, parameter and bus selector 302 may select consonant modifier 304, identify particular consonants to modify, and configure consonant modifier 304 accordingly.

Process 500 may further include forwarding the voice data to intelligibility tester 310 (block 508), and boosting the signal (e.g., injecting voice elements) into the voice data (block 510). For example, parameter and bus selector 302 may send the voice data to intelligibility tester 310. When parameter and bus selector 302 obtains an intelligibility score from intelligibility tester 310, parameter and bus selector 302 may boost the voice data in accordance with the score and provide the boosted voice data to consonant modifier 304.

Process 500 may further include modifying the boosted voice data using the selected pathology filters (block 512). For example, when consonant modifier 304 receives the boosted signal, consonant modifier 304 may detect and modify a particular set of consonants as identified by hearing profile 110. Upon obtaining the modified voice data, the pathology filters may forward the modified voice data to intelligibility tester 310 (block 514).

Process 500 may further include obtaining an intelligibility score (block 516). For example, when intelligibility tester 310 receives both the original voice data (from parameter and bus selector 302) and the modified voice data (from the pathology filters), intelligibility tester 310 may generate an intelligibility score, as described above with reference to FIG. 4. Intelligibility tester 310 may then provide the intelligibility score to parameter and bus selector 302.

Process 500 may further include performing voice compensation (block 518) and providing the compensated voice data (block 520). For example, when parameter and bus selector 302 receives the intelligibility score from intelligibility tester 310, parameter and bus selector 302 may further boost or adjust the voice signal or data in accordance with the score, such as by amplifying consonants. Parameter and bus selector 302 may then provide the compensated voice data to a device component (e.g., speakers or network interface), a network component (e.g., a 5G core component), or to a device such as UE 102.

FIG. 6 depicts exemplary components of a network device 600. Network device 600 may correspond to or be included in any of the devices and/or components illustrated in FIGS. 1, 2, 3A, 3B, and 4 (e.g., network 104, UE 102, access network 204, core network 206, data network 208, MEC 211, network slices 212, voice injector 108, voice injector system 118, etc.). In some implementations, network devices 600 may be part of a hardware network layer on top of which other network layers and network functions may be implemented.

As shown, network device 600 may include a processor 602, memory/storage 604, input component 606, output component 608, network interface 610, and communication path 612. In different implementations, network device 600 may include additional, fewer, different, or different arrangement of components than the ones illustrated in FIG. 6. For example, network device 600 may include line cards, switch fabrics, modems, etc.

Processor 602 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 600 and/or executing programs/instructions.

Memory/storage 604 may include static memory, such as read only memory (ROM), and/or dynamic memory, such as random access memory (RAM), or onboard cache, for storing data and machine-readable instructions (e.g., programs, scripts, etc.). Memory/storage 604 may also include an optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 604 may be external to and/or removable from network device 600. Memory/storage 604 may include, for example, a Universal Serial Bus (USB) memory stick, a dongle, a hard disk, off-line storage, a Blu-Ray® disk (BD), etc. Memory/storage 604 may also include devices that can function both as a RAM-like component or persistent storage, such as Intel® Optane memories. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 606 and output component 608 may provide input and output from/to a user to/from network device 600. Input/output components 606 and 608 may include a display screen, a keyboard, a mouse, a speaker, a microphone, a camera, a DVD reader, USB lines, and/or other types of components for obtaining, from physical events or phenomena, to and/or from signals that pertain to network device 600.

Network interface 610 may include a transceiver (e.g., a transmitter and a receiver) for network device 610 to communicate with other devices and/or systems. For example, via network interface 610, network device 600 may communicate over a network, such as the Internet, an intranet, cellular, a terrestrial wireless network (e.g., a wireless local area network (WLAN), WIFI, WIMAX, etc.), a satellite-based network, optical network, etc. Network interface 610 may include a modem, an Ethernet interface to a LAN, and/or an interface/connection for connecting network device 600 to other devices (e.g., a Bluetooth interface).

Communication path or bus 612 may provide an interface through which components of network device 600 can communicate with one another.

Network device 600 may perform the operations described herein in response to processor 602 executing software instructions stored in a non-transient computer-readable medium, such as memory/storage 604. The software instructions may be read into memory/storage 604 from another computer-readable medium or from another device via network interface 610. The software instructions stored in memory/storage 604, when executed by processor 602, may cause processor 602 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while series of actions, messages, and/or signals, have been described with reference to FIGS. 3A, 3B, 4 and 5, the order of the actions, messages, and signals may be modified in other implementations. In addition, non-dependent actions, messages, and signals may represent actions, messages, and signals that can be performed, sent, and/or received in parallel and in different orders. Furthermore, each of actions, messages, and signals illustrated may include one or more other actions, messages, and/or signals.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code-it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A device comprising:
a processor configured to:
receive, from a User Equipment device (UE), voice data over a data path that includes a wireless link between the UE and a network that comprises the device;
modify the received voice data in accordance with one or more hearing pathologies;
perform an intelligibility test on the received voice data and the modified voice data to obtain an intelligibility score;
boost energy of the received voice data to generate compensated voice data based on the intelligibility score; and
provide the compensated voice data to another device or a component.

2. The device of claim 1, wherein the intelligibility test includes a Short-Term Objective Intelligibility (STOI) test.

3. The device of claim 1, wherein the intelligibility test includes:
obtaining time-frequency representations of the received voice data and the modified voice data; and
extracting envelopes of the time-frequency representations.

4. The device of claim 1, wherein when modifying the voice data, the processor is configured to:
obtain an initial intelligibility score; and
boost an energy of the voice data to obtain boosted voice data.

5. The device of claim 4, wherein when modifying the voice data, the processor is further configured to:
modify the boosted voice data based on configuration parameters.

6. The device of claim 5, wherein when modifying the boosted voice data based on the configuration parameters, the processor is configured to:
modify portions, of the voice data, which correspond to consonant sounds.

7. The device of claim 6, wherein when modifying the portions of the voice data, the processor is configured to:
identify the consonant sound by using a Hidden Markov Model that is trained based on Mel-Frequency Cepstrum coefficients (MFCC).

8. The device of claim 1, wherein the processor is further configured to:
obtain hearing profile that includes hearing pathology data, and wherein when modifying the voice data, the processor is configured to:
identify pathologies based on the pathology data included in the hearing profile; and
degrade the voice data based on the identified pathologies.

9. The device of claim 1, wherein the processor is further configured to:
obtain the hearing pathology data from a hearing test.

10. A method comprising:
receiving, by a device and from a User Equipment device (UE), voice data over a data path that includes a wireless link between the UE and a network that comprises the device;
modifying the received voice data in accordance with one or more hearing pathologies;
performing an intelligibility test on the received voice data and the modified voice data to obtain an intelligibility score;
boosting energy of the received voice data to generate compensated voice data based on the intelligibility score; and
providing the compensated voice data to another device or a component.

11. The method of claim 10, wherein the intelligibility test includes a Short-Term Objective Intelligibility (STOI) test.

12. The method of claim 10, wherein the intelligibility test includes:
obtaining time-frequency representations of the received voice data and the modified voice data; and
extracting envelopes of the time-frequency representations.

13. The method of claim 10, wherein modifying the voice data includes:
obtaining an initial intelligibility score; and
boosting an energy of the voice data to obtain boosted voice data.

14. The method of claim 13, wherein modifying the voice data includes:
modifying the boosted voice data based on configuration parameters.

15. The method of claim 14, wherein modifying the boosted voice data based on the configuration parameters includes:
modifying portions, of the voice data, which correspond to consonant sounds.

16. The method of claim 15, wherein modifying the portions of the voice data includes:
identifying the consonant sound by using a Hidden Markov Model that is trained based on Mel-Frequency Cepstrum coefficients (MFCC).

17. The method of claim 10, further comprising:
obtaining hearing profile that includes hearing pathology data, and,
wherein modifying the voice data includes:
identifying pathologies based on the pathology data included in the hearing profile; and
degrading the voice data based on the identified pathologies.

18. The method of claim 10, further comprising:
obtaining the hearing pathology data from a hearing test.

19. A non-transitory computer-readable medium comprising processor-executable instructions, which when executed by a processor included in a device, cause the processor to:
receive, from a User Equipment device (UE), voice data over a data path that includes a wireless link between the UE and a network that comprises the device;
modify the received voice data in accordance with one or more hearing pathologies;
perform an intelligibility test on the received voice data and the modified voice data to obtain an intelligibility score;
boost energy of the received voice data to generate compensated voice data based on the intelligibility score; and
provide the compensated voice data to another device or a component.

20. The method of claim 10, wherein the intelligibility test includes a Short-Term Objective Intelligibility (STOI) test.
